(19) United States
(12) Patent Application Publication
(10) Pub. No.: US 2010/0066234 A1
(43) Pub. Date: Mar. 18, 2010

(54) Connector for CCFL, CCFL with connector and display device

(75) Inventors: Yuichi Mori, Saitama (JP); Shinsaku Tanaka, Saitama (JP)

Correspondence Address: BACHMAN & LAPOINTE, P.C., 900 CHAPEL STREET, SUITE 1201, NEW HAVEN, CT, 06510, US

(73) Assignee: Sanken Electric Co., Ltd., Saitama (JP)

(21) Appl. No.: 12/209,241

(22) Filed: Sep. 12, 2008

(51) Int. Cl. H01J 5/50; H01J 9/00

(52) U.S. Cl. 313/318.12; 445/23

(57) ABSTRACT

A connector is provided which comprises a metallic sleeve 1 to be attached to an access end 21a of a glass tube 21 in a discharge tube 20, and metallic sleeve 1 is formed into a gapped ring section with longitudinal opposite ends for defining a gap 17. Sleeve 1 can be radially expanded due to gap 17 to attach it to glass tube 21 and firmly be retained on glass tube 21 due to resilient force of sleeve 1 for shrinking the diameter. This arrangement ensures the prevention of misalignment or detachment of sleeve 1 on glass tube 21 even when some external force is applied to sleeve 1 when discharge tube 20 is mounted on a holder, while restricting stress conveyance to a lead 22 of discharge tube 20.

### TECHNICAL FIELD

This invention relates to a connector attached to opposite ends of a glass tube for use in an electric discharge tube, an electric discharge tube with the connector, manufacture thereof and display device.

### BACKGROUND OF THE INVENTION

Electric discharge tubes (cold cathode fluorescent discharge tube lighting or CCFL) have been used as backlight sources of LCD (Liquid Crystal Display) for television monitors, laptop computers, display devices in mobile phones. As shown in FIG. 21, a known electric discharge tube 20 comprises a glass tube 21 for defining a closed space 23 in which discharge gases such as argon and mercury are sealed or entrapped in the airtight structure, a pair of metallic electrodes 24 each formed into a cup-like shape and located in opposite ends of closed space 23, a metallic lead 22 having one end connected to each of metallic electrodes 24 and the other end led out of each end of glass tube 21, and a fluorescent layer 25 coated on inner surfaces of glass tube 21 for glowing upon receiving ultra-violet light produced due to electricity discharge from electrodes 24. Display devices as above-mentioned have a plastic holder (not shown) for supporting or grasping a glass tube 21 behind a liquid crystal panel in LCD and adjacent to a light guide plate. Wires or metallic conductors are connected to leads 22 with solder to supply electric power to discharge tube 20 through wires so that discharge tube 20 radiates light on liquid crystal panel from the back side thereof.

Meanwhile, Japanese Patent Disclosure No. 11-329047 published Nov. 30, 1999 demonstrates a metallic discharge tube retainer or holder which comprises a base plate, a conductor provided on the base plate, and a bracket attached to each end of the base plate. The bracket has an electrode retainer vertically bent at the end of the base plate to support a lead in a discharge tube on the retainer. To this end, the retainer has a channel-shaped resilient clip for receiving a lead of discharge tube to supply electric power to discharge tube through the conductor, bracket and electrode retainer. This structure is beneficial because the lead of discharge tube can be electrically connected to electrode retainer due to elasticity of clip with omission of soldering process to thereby improve activity of connecting discharge tube and power source. This structure, however, is disadvantageous because some stress is applied to lead of discharge tube when it is attached to resilient clip of the retainer so that cracks may occur in glass tube around lead and thereby discharge gas within glass tube undesirably leaks outside through cracks in glass tube for many hours as a slow leaking. The structure shown by the above patent document has an elongated erect connection formed of elastic metal for connecting the retainer and clip which can alleviate or absorb shock produced when lead of discharge tube is attached to clip. However, this discharge tube retainer is still defective because the bracket for directly supporting the lead of discharge tube cannot reduce a full amount of stress applied to the lead to completely prevent cracks from being caused in glass tube.

On the other hand, Japanese Utility Model Disclosure No. 64-48851 published Mar. 27, 1989, exhibits a metallic cap covered on an end of glass tube. A lead of discharge tube is inserted into an opening formed at a tip of the bottom of the cap, and solder is applied to the opening to secure the cap on the way of lead. The cap attached to an end of glass tube is supported and gripped by a U-shaped holder. This structure allows electric power to be supplied to discharge tube through the cap and U-shaped holder. In assemblage, metallic caps are attached to opposite ends of glass tube in such a condition that an inner circumferential surface of caps is in close contact to an outer circumferential surface of glass tube. Accordingly, during lighting of discharge tube, opposite ends of glass tube are locally cooled at a lower temperature than that at an interior side of discharge tube because heat produced from discharge tube is transferred outside through caps and holders. Then, the lowered temperature tends to cause mercury in glass tube to concentrate at opposite ends of glass tube, and this is liable to prevent discharge tube from emitting lengthwise uniform amount of light and also to shorten service life of discharge tube. On the other hand, another discharge lamp device of new structure has been proposed which comprises a cap formed with a plurality of inward bosses or beads for defining a space between the cap and glass tube so that an air layer in the space provides thermal insulation to prevent local cooling of glass tube by heat transfer through the cap. Reference should be made to Japanese Patent Disclosure No. 3-285231 published Dec. 16, 1991 representing a cap or sleeve attached to opposite ends of glass tube so that a pair of inward inclined bosses formed on the cap may possibly provide an air space between the cap and glass tube.

However, when the cap attached to an end of glass tube is fit in a clip of holder to attach discharge tube to the holder, the cap may disadvantageously be moved out of a proper position on glass tube due to an external force applied to the cap. In particular, clearance formed between the cap and glass tube unfavorably facilitates slippage of the cap on glass tube, and the misalignment of the cap on glass tube may induce a stress on a lead of discharge tube to cause cracks in glass tube.

Accordingly, an object of the present invention is to provide a connector for electric discharge tube capable of reducing stress produced in a lead of discharge tube, and also to provide an electric discharge tube with such a connector, manufacture thereof and display device.

### SUMMARY OF THE INVENTION

The connector for an electric discharge tube according to the present invention, comprises an electrically conductive metallic sleeve (1) of a generally gapped cylindrical shape formed with a pair of longitudinal opposite side edges in spaced relation to each other to define a longitudinal gap or notch (17) therebetween. When an access end (21a) of a glass tube (21) of discharge tube (20) is inserted into sleeve (1) through an receiving end (1c) thereof, longitudinal side edges of sleeve (1) are moved in the circumferential direction away from each other to widen gap (17) so that sleeve (1) is forcibly expanded from the original diameter to the enlarged diameter which allows access end (21a) of glass tube (21) to be put into sleeve (1) against a resilient force of sleeve (1). Accordingly, once attached, sleeve (1) is retained on access end (21a) of glass tube (21) due to resilient force of sleeve (1) which firmly grasps glass tube (21) in position. Accordingly, even if a certain level of external force is applied to sleeve (1) upon attachment of discharge tube (20) to a holder, sleeve (1) is not detached or disengaged from glass tube (21) while thereby alleviating stress to a lead (22) of discharge tube (20).

In another aspect, the connector for discharge tube according to the present invention, comprises a sleeve (1), a strip (2) extending outwardly in the axial direction from a distal end (1a) of sleeve (1) and a contact (3) formed as a bend at a tip (2a) of strip (2) with a penetration or notch (13). A metallic material is used to form sleeve (1), strip (2) and contact (3). When sleeve (1) is attached to access end (21a) of glass tube (21), a lead (22) extending from access end (21a) of glass tube (21) is disposed in penetration or notch (13) of contact (3). Strip (2) and contact (3) are formed into an elongated narrow band shape to bear elasticity and flexibility so that they can easily deform when receiving some stress from sleeve (1). Thus, when some stress occurs in sleeve (1), strip (2) and contact (3) serve to reduce stress transferred from sleeve (1) to lead (22) in order to prevent cracks from generating in glass tube (2) around lead (22). When sleeve (1) of the connector is attached to the metallic holder led to any power source, electric power can be supplied to lead (22) of discharge tube (20) from power source through holder, sleeve (1), strip (2) and contact (3) to lighten discharge tube (20). In this way, when sleeve (1) is attached to holder, strip (2) operates to ease mechanical stress loaded on sleeve (1) and thereby prevent transmission of large stress to lead (22) of discharge tube (20).

In assemblage of discharge tube and connector or in attachment of discharge tube to a display device, the strip can contribute to reduce stress propagated from connector to lead of discharge tube and to thereby prevent occurrence of cracks in glass tube around lead in order to provide a highly reliable discharge tube and light source device.

### BRIEF DESCRIPTION OF THE DRAWINGS

The above-mentioned and other objects and advantages of the present invention will be apparent from the following description in connection with preferred embodiments shown in the accompanying drawings wherein:

FIG. 1 is a sectional view of a first embodiment showing a discharge tube to which a connector according to the present invention is attached;

FIG. 2 is a sectional view of the connector shown in FIG. 1 taken along a central axis of the discharge tube;

FIG. 3 is a sectional view of the connector shown in FIG. 1 taken along a flat plane perpendicular to the central axis of the discharge tube;

FIG. 4 is a plan view of the connector shown in FIG. 1;

FIG. 5 is a plan view of a plate material to be formed into the connector of FIG. 1;

FIG. 6 is a perspective view of the connector shown in FIG. 1;

FIG. 7 is an operational flow chart diagram showing sequential processes for attaching the connector to the discharge tube;

FIG. 8 is a sectional view of a holder;

FIG. 9 is an operational flow chart diagram showing sequential processes for attaching to the holder the discharge tube with the connector;

FIG. 10 is a perspective view showing another embodiment of a strip provided;

FIG. 11 is a perspective view showing another embodiment of a contact provided;

FIG. 12 is a sectional view of the discharge tube shown in FIG. 1 with the connector and a folded strip extending therefrom;

FIG. 13 is a perspective view showing another embodiment of a holder;

FIG. 14 is a plan view showing a second embodiment of the discharge tube with a connector according to the present invention;

FIG. 15 is a bottom view of the discharge tube with the connector shown in FIG. 14;

FIG. 16 is a side elevation view of the discharge tube with the connector shown in FIG. 14;

FIG. 17 is an enlarged partial view showing an inward projection formed in the connector shown in FIG. 14;

FIG. 18 is a front view of the discharge tube with the connector shown in FIG. 14;

FIG. 19 is a front view of the discharge tube and connector shown in FIG. 18 but with a forged contact of the connector together with a lead of the discharge tube;

FIG. 20 is a sectional view of a third embodiment of the discharge tube with the connector according to the present invention; and

FIG. 21 is a sectional view of a prior art discharge tube.

### BEST MODE FOR CARRYING OUT THE INVENTION

In connection with FIGS. 8 to 16 of the drawings, embodiments will be described hereinafter of the connector according to the present invention applied to a cold cathode fluorescent discharge tube for use in a backlight of a display device. Also, embodiments of discharge tubes, manufacture thereof and display devices will be described relevant to the connectors according to the present invention. Discharge tubes shown by reference numeral 20 in these drawings are the same as that shown in FIG. 21 by the same reference numeral 20, and therefore, further explanation thereon is omitted.

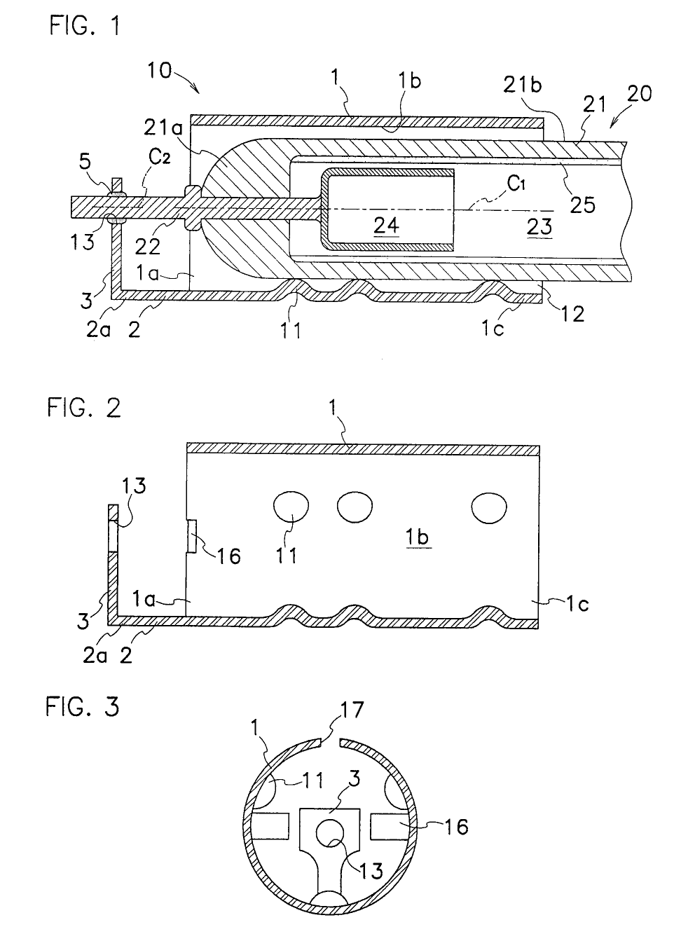

As shown in FIG. 1, the connector 10 for discharge tube according to a first embodiment of the invention, comprises a sleeve 1 as attachment means, a belt-like elongated strip 2 extending outward from distal end 1a of sleeve 1 in the axial direction, and a contact 3 formed as a bent or folded end of strip 2. Sleeve 1 is formed into a generally tubular or cylindrical shape of an annular section, and has opposite distal and proximal ends 1a and 1c open to outside. Distal end 1a of sleeve 1 is connected to strip 2 and proximal end 1c forms an opening into which discharge tube 20 is inserted. Sleeve 1, strip 2 and contact 3 are integrally formed of an electrically conductive metallic material excellent in elasticity such as phosphor bronze or stainless steel with surface treatment by nickel plating. As illustrated in FIG. 2, sleeve 1 is provided with a plurality of hemispherical radially-inward bosses 11 which serve to contact or confront and retain glass tube 21 in position within sleeve 1. Bosses 11 also help to provide sleeve 1 with increased mechanical strength against deformation. Bosses 11 may be made in the form of inward beads, dimples or other protrusion means to define a generally cylindrical clearance or space 12 between sleeve 1 and sealed access end 21a of glass tube 21 inserted into sleeve 1. As shown in FIGS. 2 and 3, this embodiment includes nine (9) bosses 11 with three sets angularly and axially spaced from each other, however, one of ordinary skill in the art could adopt different number, size and shape of bosses 11 for example depending on size of sleeve 1. Preferably, bosses 11 have a smooth tip which comes into contact to glass tube 21. Ideally, all bosses 11 are uniformly in contact to glass tube 21, however, some of them may be in non-contact to glass tube 21 so long as connector 10 is attached to access end of discharge tube 20 in position. As lead 22 of discharge tube 20 is mechanically joined to contact 3 of connector 10, only axially inward bosses 11 near proximal or receiving end 1c of connector 10 provide enough support to relatively stably hold discharge tube 20 on connector 10 as a cap rather without axially middle or outward bosses 11 which may cause disadvantageous partial cooling of discharge tube 20. Connector 10 has a pair of longitudinal opposite side edges in spaced relation to each other to define a longitudinal abutment or gap 17 therebetween. When access end 21a of glass tube 21 of discharge tube 20 is inserted into sleeve 1 through distal end 1a thereof, longitudinal side edges of sleeve 1 are moved in the circumferential direction away from each other to widen gap 17 so that sleeve 1 is forcibly expanded from the original diameter to the enlarged diameter which allows the sealed access end 21a of glass tube 21 to be put into sleeve 1 against resilient force of sleeve 1. As sleeve 1 is formed of an elastic metallic material into a generally loop section with gap 17, sleeve 1 can be expanded from the original diameter against its elasticity or resilient force when sleeve 1 is attached to access end 21a of glass tube 21. Accordingly, once attached, sleeve 1 is retained on access end 21a of glass tube 21 due to resilient force for shrinking diameter of sleeve 1 which firmly grasps glass tube 21 in position. In this condition, bosses 11 of sleeve 1 are in direct contact to an outer circumferential surface 21b to retain sleeve 1 on access end 21a of glass tube 21. In other words, rigid bosses 11 can provide a firm and flexible grasping structure in collaboration with gapped sleeve 1 for producing a radially shrinking force so that the grasping structure effectively prohibits misalignment or detachment of sleeve 1 from glass tube 21 while bosses 11 certainly defines a generally annular or cylindrical space 12 between glass tube 21 and sleeve 1, and the grasping structure is effective for steady attachment of glass tube 21 to connector 10. Also, when lead 22 of discharge tube 20 is secured to contact 3 of connector 10, strip 2 can fully alleviate and absorb possible stress in lead 22 and prevent generation of disadvantageous cracks in glass tube 21 around lead 22 without slow leak of discharge gas within discharge tube 20 through cracks. Integrally formed with sleeve 1 are stoppers 16 radially inwardly extending from sleeve 1 to bring access end 21a of inserted glass tube 21 into contact to stoppers 16 in order to deploy sleeve 1 in position of glass tube 21.

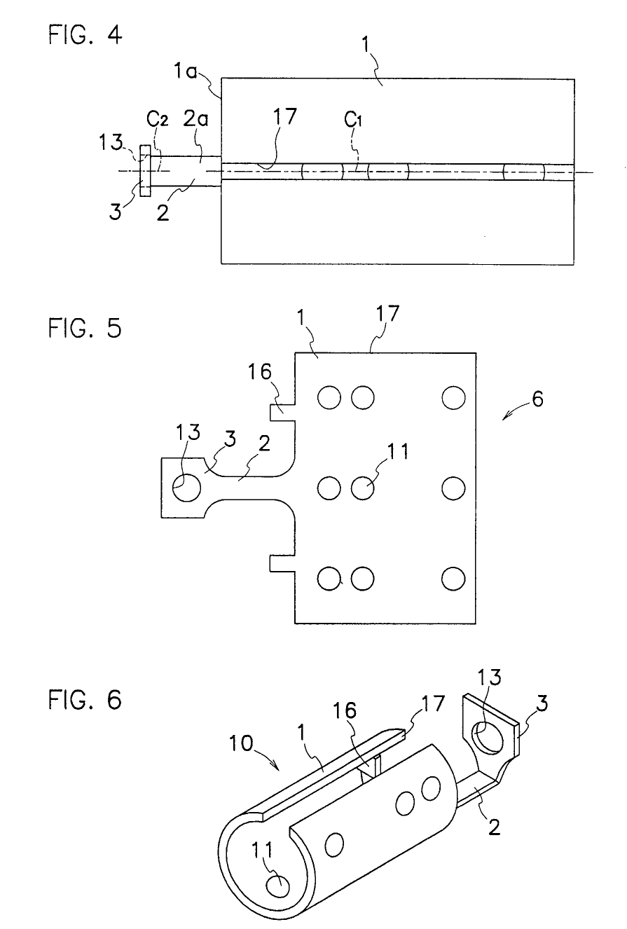

As understood from FIG. 4, strip 2 has a narrower width than those of sleeve 1 and contact 3 to produce flexibility in the perpendicular or vertical direction. In this embodiment, strip 2 has the thickness same as those of contact 3 and sleeve 1, but width and length of strip 2 are determined as required depending on required flexibility for strip 2. Preferably, contact 3 has the shape capable of griping or holding and also electrically connecting lead 22 of discharge tube 20. As shown in FIGS. 1 and 4, contact 3 has a circular penetration or through-hole 13 whose central axis C₂ is in alignment with and an extension of central axis C₁ of sleeve 1. Also, penetration 13 has a larger inner diameter than outer diameter of lead 22 of discharge tube 20. When sleeve 1 is capped on access end 21a of glass tube 21, lead 22 extending from access end 21a is located in penetration 13 of contact 3. Size and shape of penetration 13 are determined accordingly taking into account of workability of inserting lead 22 of discharge tube 20 into penetration 13 of contact 3 and operability of jointing lead 22 and contact 3 by means of brazing metal 5. Contact 3 and lead 22 of discharge tube 20 may be fastened together by welding, forging or combination thereof without brazing metal 5.

Both strip 2 and contact 3 have such elasticity and flexibility that they easily resiliently and recoverably bend, deflect, twist or skew once receiving external force, and so even if sleeve 1 is moved from the appropriate position on glass tube 21, strip 2 and contact 3 easily and recoverably alter the shape to prevent transmission of external force to lead 22 and, as a result, deter generation of cracks in glass tube 21. In addition, formed by bosses 11 between sleeve 1 and glass tube 21 is the space 12 which provide a thermally insulating air layer to fully inhibit local cooling of glass tube 21 due to heat transfer through bosses or sleeve 1 so that the air layer is useful to keep discharge tube 20 from deterioration in light emission property. Therefore, bosses are referred to as spacer means for defining the space 12 in which thermally insulating air layer is reserved between sleeve 1 and glass tube 21.

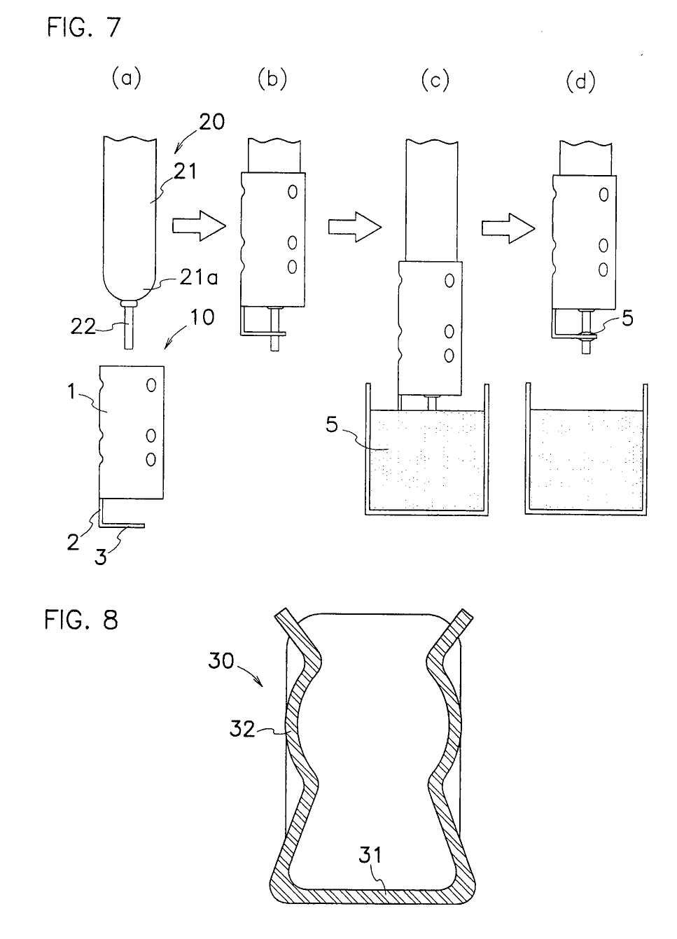

In preparing connector 10, provided is a flat metallic plate material 6 shown in FIG. 5 integrally formed of a metallic plate sheet punched by press forming which has flat strip 2, contact 3 and stoppers 16. Then, plate material 6 is formed by bending into a cylindrical shape to fabricate sleeve 1, and further, contact 3 and stoppers 16 are folded to finish a connector 10 shown in FIG. 6. After that, as shown in FIGS. 7(a) and 7(b), sleeve 1 of connector 10 is capped on access end 21a of glass tube 21, and relatively, discharge tube 20 is introduced into sleeve 1 from receiving end 1c. Accordingly, lead 22 is moved in parallel to and along strip 2, and is inserted into penetration 13 of contact 3 until access end 21a of glass tube 21 comes into contact to stoppers 16 which serve to arrange connector 10 in position of discharge tube 20.

Consequently, a molten brazing metal 5 is applied to a junction of contact 3 and lead 22 to electrically connect connector 10 and lead 22 of discharge tube 20. For example, as shown in FIGS. 7(c) and 7(d), at least, penetration 13 of contact 3 and lead 22 can be dipped in molten brazing metal bath, and then, are cooled to join them with the attached brazing metal 5 by a simplified brazing process at a reduced cost for manufacture, and thereby, finish attachment of connector 10 to discharge tube 20. In a prior art troublesome technique, lead 22 of discharge tube 20 was manually connected to a wire with solder.

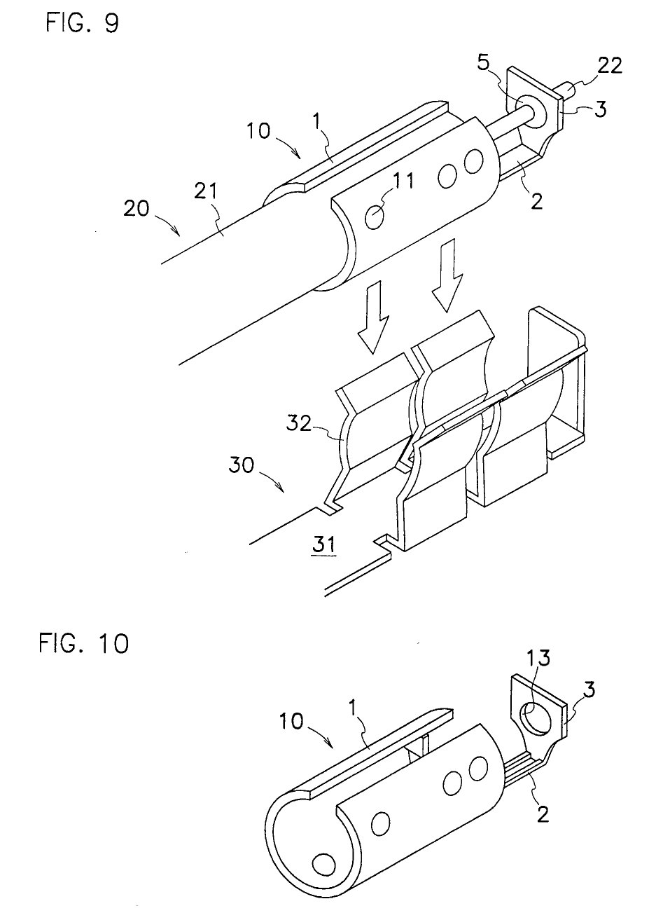

Subsequently, to incorporate discharge tube 20 with connector 10 in a display device (not shown), a metallic holder 30 is mounted behind an LC panel (not shown) and adjacent to a light guide plate (not shown), and is connected to a power source of the display device through suitable wires or cables. As illustrated in FIG. 8, holder 30 comprises a base 31 secured on display device, and pairs of elastic arms 32 integrally formed with and extending upwardly from base 31. As will be understood from FIG. 9, connector 10 capped on sealed access end 21a of discharge tube 20, is sandwiched between intermediate arcs formed with opposite arms 32. When connector 10 is pushed from above, it is forcibly and easily snapped between arcs of arms 32 with one pushing operation of connector 10 against elastic force of arms 32. In this situation, when connector 10 is pushed toward arms 32, they are moved away from each other once, and then, returned by their own elasticity to the position that resiliently and firmly holds connector 10 between arcs of arms 32 when connector has completely fit between arms 32. Not shown in the drawings, but a pair of connectors 10 are attached to opposite sealed ends 21a of glass tube 21. As will be apparent from the foregoing, discharge tube 20 can emit light because electric power is supplied to opposite leads 22 of discharge tube 20 from power source of the display device through each holder 30, sleeve 1 grasped between arms 32 of holder 30 and contact 3. Over again, strip 2 and contact 3 can act to reduce or absorb external force associated with setting connector 10 into holder 30 and thereby prevent large stress from transmitting to lead 22 and glass tube 21 through sleeve 1.

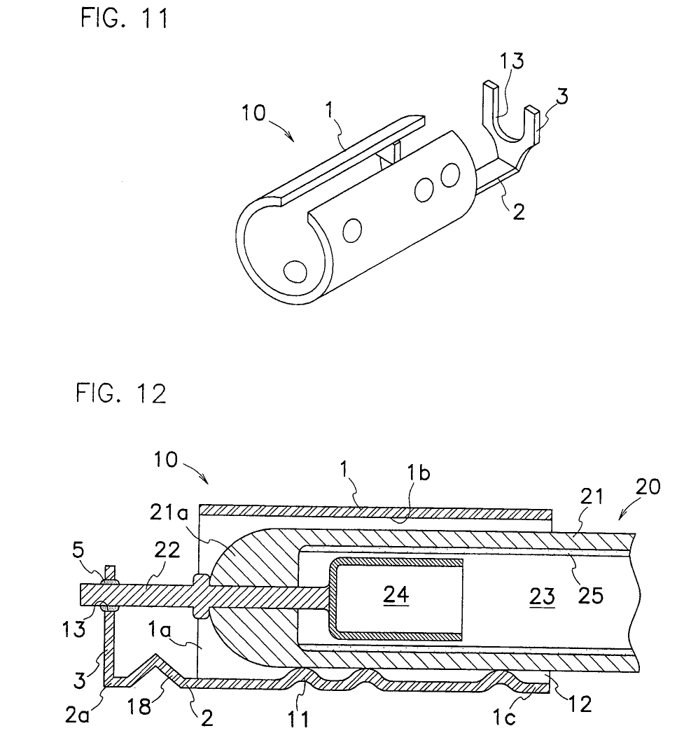

Embodiments of the present invention should not be limited to those shown in FIGS. 1 to 9 and in addition thereto or instead thereof, they may be further varied or modified in various ways. For example, instead of bosses 11, tongues like lugs or fingers may be formed in sleeve 1 as abutment means. Each of tongues has one end connected to sleeve 1 and opposite side edges and the other free end cut out of sleeve 1 to provide cantilever tongues with elasticity. Each of free ends inwardly inclines and projects to come into contact to outer circumferential surface of glass tube 21. In this case, tongues may be formed in the axial direction toward either or both of distal and proximal ends 1a, 1c of sleeve 1. These tongues act as leaf springs for elastically supporting sleeve 1 attached to access end 21a of glass tube 21. Accordingly, in place of three bosses 11 formed in the circumferential direction in angularly spaced relation to each other, a single tongue may be used. As shown in FIG. 10, strip 2 of connector 10 may comprise a plurality of axial strip pieces. Also, without limitation to a circular shape, penetration 13 of contact 3 may be formed into a square, rectangular or polygonal opening. As depicted in FIG. 11, contact 3 may have a Y-shaped section or U-shaped notch. As represented in FIG. 12, strip 2 may have at least one deflection 18 such as fold or bend which may increase or produce its own elasticity capable of expanding or shrinking in the axial direction to absorb or ease stress transmitted from sleeve 1 to contact 3 as glass tube 21 thermally expands and shrinks upon lighting and lights-out of discharge tube 20. Bosses 11 can contact glass tube 21 slidably in the axial direction to allow relative axial movement between bosses 11 and glass tube 21, and at the same time, bosses 11 can support glass tube 21 in the radial direction of sleeve 1 to form space 12 between sleeve 1 and glass tube 21. Accordingly, even with the structure of bonding lead 22 in discharge tube 20 to contact 3 of connector 10, sleeve 1 may still move in the axial and radial directions with respect to glass tube 21, and this structure can absorb thermal expansion and shrinkage of glass tube 21 by flexibility and elasticity or deformation of strip 2 and axial and radial movement of sleeve 1 relative to glass tube 21 without effecting harmful stress to the joint portion of lead 22 and contact 3. Thus, this structure can effectively curb occurrence of cracks in glass tube 21 around lead 22 that may unfavorably result in slow leak of discharge gas. Deflection or deflections 18 enable strip 2 to flex, deflect or deform in the longitudinal or axial and transverse two directions so as to attenuate stress loaded on lead 22.

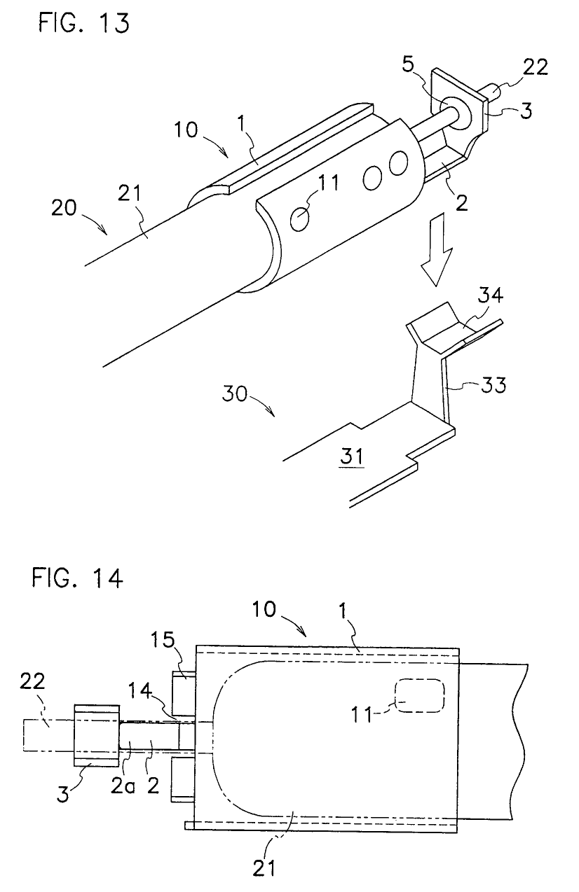

FIG. 13 shows a holder 30 provided with an elongated erect connection 33 similar to that shown in Japanese Patent Disclosure No. 11-329047, and holder 30 to which connector 10 of the invention is attached, may have elongated erect connection 33 vertically extending from base 31. Formed at the top of erect connection 33 is an uphold 34 which can bear strip 2 and/or contact 3 of connector 10 which can be attached to holder 30 as at least erect connection 33 helps to reduce possible shock produced to glass tube 21 upon attachment of connector 10 to holder 30. Likewise, brazing metal may be used to securely join uphold 34 and strip 2 and/or contact 3 whereby discharge tube 20 can be fixed on holder 30 via connector 10. The illustrated embodiment, brazing metal 5 is used to bond contact 3 of connector 10 and lead 22 of discharge tube 20 before they are mounted in display device, however, contact 3 and lead 22 may be joined by brazing after they are built in display device.

Sleeve 1 of connector 10 shown in FIGS. 14 to 20 has distal end 1a yet formed with a pair of cutouts or indents 14 adjacent to and on opposite sides of strip 2 to substantially extend the length of strip 2 and thereby obtain increased elasticity of strip 2 which can more weaken stress spreading between sleeve 1 and contact 3. Cutouts 14 have a small volume that does not reduce a significant amount of thermal capacity in sleeve 1, and therefore, when heat is transferred from lead 22 of discharge tube 20 on to contact 3, strip 2 and sleeve 1, a sufficient amount of heat can be radiated outside through sleeve 1 to prevent thermal deformation of connector 10 and/or holder 30 even under the overheated environment. In another aspect, heat is hardly transmitted from glass tube 21 to sleeve 1 because glass tube 21 is in contact to sleeve 1 only through small area of bosses 11, and thermally insulating air layer in space 12 bars substantial conduction of heat from glass tube 20 to sleeve 1 to thereby prevent brightness degradation or lighting failure of discharge tube 20 due to temperature drop in glass tube 21. Also, a further embodiment shown in FIGS. 15 to 17, comprises only bosses 11 in the vicinity of proximal end 1c of sleeve 1 so that bosses 11 are away from lead 22 and electrode 24 of discharge tube 20 along the accompanied heat transfer path. In this arrangement, heat from electrode 24 and lead 22 of discharge tube 20 is radiated only through bosses 11 and sleeve 1 to guard discharge tube from temperature drop. Bosses 11 shown in FIGS. 15 to 17 have an easier gradient of slope toward proximal end 1c of sleeve 1 than that toward distal end 1a. This gentler slope of bosses 11 makes it easier to cap connector 10 on discharge tube 10 with less damage to glass tube 21 than that with hemispherical bosses 11 shown in FIGS. 1 to 13.

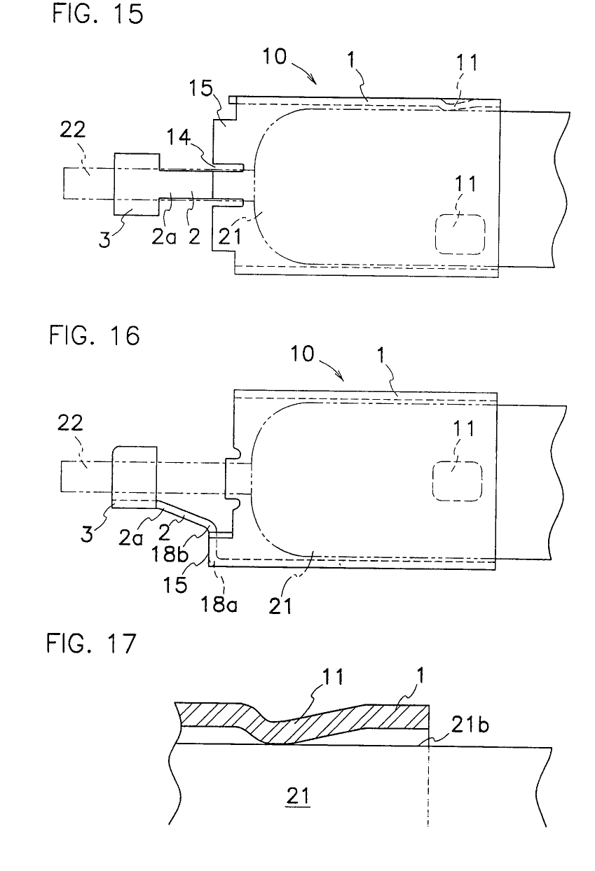

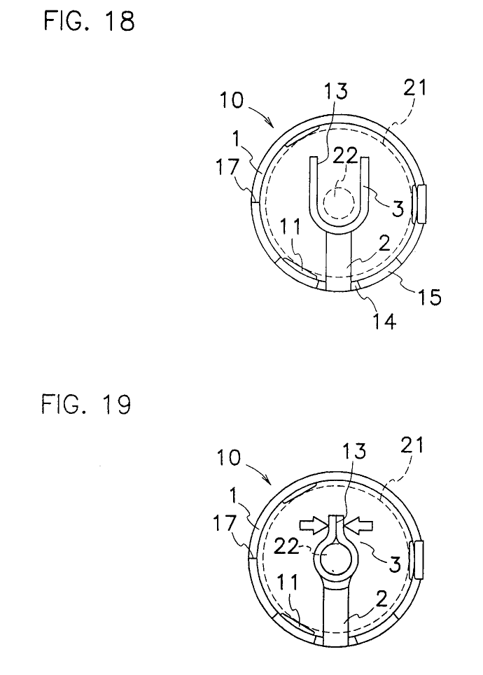

As shown in FIG. 18, contact 3 has a U-shaped grip formed in one unit with a semicircle bottom around an central longitudinal axis C₁ of sleeve 1 and connected to strip 2, and two straight limbs extending upward from each end of the semicircle bottom. Whereas contact 3 shown in FIG. 11 is formed into a U-shape in thickness of contact 3 by cutting down a part of a metallic plate, one shown in FIG. 18 is formed into a U-shape in length of contact 3 by bending parts of a blank metallic plate. In lieu of U-shaped section, contact 3 may be formed into a different section like V- or C-shaped section. As shown in FIG. 16, strip 2 comprises a first bend 18a deflected from the horizontal to the vertical direction, and a second bend 18b further deflected from the vertical to the obliquely upward direction toward a tip of lead 22 of discharge tube 20. When a clamping force is applied for forging to at least opposite tops of limbs in contact 3 in the closing direction shown by arrows in FIG. 19 by means of any suitable forging means (not shown in the drawings), contact 3 can be fixed to lead 22 of discharge tube 20. Then, any welding technique such as laser welding can be applied to contact 3 to fuse and firmly bond it to lead 22. Arcuate extensions 15 are protruded from distal end 1a of sleeve 1 to utilize extensions 15 for positioning of the forging means. In the shown embodiment, a pair of extensions 15 are formed on the opposite sides of strip 2 adjacent to cutouts 14. Alternatively, strip 2 may be used to position the forging means. Compared to contact 3 shown in FIG. 1, contact 3 shown in FIG. 16 can electrically connect connector 10 and lead 22 more reliably because it has a wider area with the longer axial size to connect it with lead 22 of discharge tube.

Unlike gap 17 formed at the top of sleeve 1 on the opposite side of the bottom of sleeve 1 connected to strip 2 as in FIG. 3, gap 17 shown in FIGS. 18 and 19 is formed at a circumferential side position angularly apart from the top of sleeve 1 by angle 90 degrees. There may occur a defect in sleeve 1 shown in FIG. 3 because longitudinal side edges of sleeve 1 are moved away from each other by the own weight of sleeve 1, expanding gap 17 when connector 10 is attached to discharge tube 20 with sleeve 2 under tube 20, and it will be unable to stably hold itself on glass tube 21 due to the spacing movement of longitudinal side edges, however, this will be overcome or improved in sleeve 1 shown in FIG. 18 because it can prevent expansion by weight of sleeve 1 of gap 17 located on the side to surely retain sleeve 1 on glass tube 21.

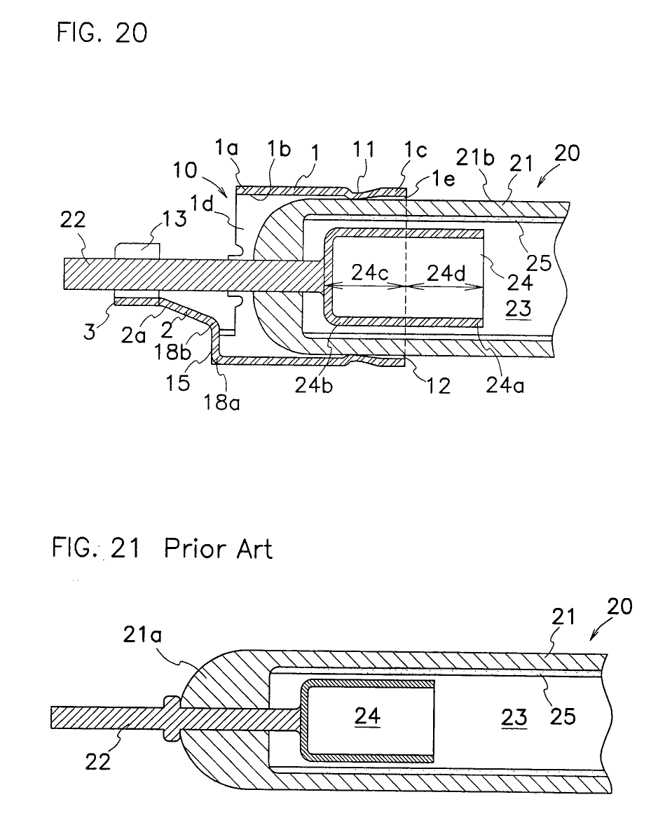

Sleeve 1 of connector 10 shown in FIG. 20 comprises a first opening 1d on the axially outward position and a second opening 1e on the axially inward position. Second opening 1e of sleeve 1 is disposed outside of an inner tip 24a of electrode 24 in discharge tube 20 to divide electrode 24 into two portions, namely an outer portion 24c enveloped by sleeve 1 and an inner portion 24d exposed from sleeve 1. In this arrangement, sleeve 1 desirably does not block light emitted outside from inner tip 24a of electrode 24 because second opening 1e does not axially extend beyond inner tip 24a of electrode 24. However, otherwise, second opening 1e may be substantially at the axially same location as that of inner tip 24a of electrode 24. Lead 22 of discharge tube 20 is connected to a bottom wall 24b of electrode 24 formed into a cup-shape. Connector 10 shown in FIG. 20 has a shorter axial length than that of connector 10 shown in FIGS. 1 to 16, and therefore, connector 10 of FIG. 20 may reduce a lost amount of light masked by sleeve 1 and thereby essentially increase emission amount of light from discharge tube 20.

The present invention is preferably applicable to cold cathode fluorescent discharge tubes for use in light sources for backlight of LCD.

What is claimed are:

1. A connector for a discharge tube, comprising a sleeve which can produce a resilient force for shrinking a diameter of the sleeve,
said sleeve being formed with a pair of opposite longitudinal side edges for forming a gap, and
said longitudinal side edges being capable of moving away from each other in the circumferential direction of the sleeve to expand the gap when the sleeve is attached to an end of a glass tube in the discharge tube.

2. The connector of claim 1, wherein said sleeve has a plurality of radially inwardly projecting bosses in contact to an outer circumferential surface of the grass tube end to which the sleeve is attached.

3. The connector of claim 2, wherein a space is formed between the sleeve and glass tube by spacing the sleeve from the glass tube through the bosses on the sleeve.

4. The connector of claim 1, wherein three bosses are formed on the sleeve in an angularly spaced relation to each other.

5. A discharge tube with a connector attached thereto, comprising a glass tube to which the connector can be attached,
each of said connectors comprising an electrically conductive metallic sleeve attached to an end of the glass tube,
said sleeve having a pair of opposite longitudinal side edges for forming a gap therebetween,
said longitudinal side edges of the sleeve being moved away from each other to expand the gap in the circumferential direction of the sleeve when the sleeve is attached to ends of the glass tube in the discharge tube.

6. The discharge tube of claim 5, wherein the sleeve comprises a plurality of radially inward bosses in contact to the circumferential surface of the grass tube end to which the sleeve is attached.

7. The discharge tube of claim 6, wherein a space is formed between the sleeve and glass tube by spacing the sleeve from the glass tube through the bosses on the sleeve.

8. The discharge tube of claim 5, wherein three bosses are formed on the sleeve in an angularly spaced relation to each other.

9. The discharge tube of claim 5, further comprising an elongated strip extending from the sleeve, and a contact formed at a tip of the strip and connected to a lead extruded from an end of the glass tube,
said sleeve, strip and contact being formed of a metallic material.

10. The discharge tube of claim 5, wherein the sleeve comprises an axially outward first opening and an axially inward second opening,
said second opening is disposed at the position axially substantially same as or outside of a tip of an electrode in the discharge tube.

11. A method for producing a discharge tube with a connector, comprising the steps of preparing a discharge tube provided with a glass tube,
preparing a sleeve formed of a metallic material with a pair of opposite longitudinal side edges for providing a gap therebetween, and
attaching the sleeve to at least one end of the glass tube.

12. A connector comprising a sleeve to be attached to an end of a glass tube in a discharge tube,
the sleeve having a plurality of radially inwardly protruding bosses which are in contact to a circumferential surface of the glass tube when the sleeve is attached to an end of the glass tube.

13. The connector of claim 12, wherein the radially inwardly protruding three bosses are formed in an angularly spaced relation to each other.

14. A discharge tube with a connector attached thereto, comprising a glass tube to which the connector is attached,
the connector comprising a metallic sleeve attached to an end of the glass tube, and
the sleeve comprising a plurality of radially inwardly protruding bosses in contact to a circumferential surface of the glass tube.

15. The discharge tube of claim 14, wherein the radially inwardly protruding three bosses are formed in an angularly spaced relation to each other.

16. A connector for a discharge tube, comprising attachment means, an elongated strip and a contact formed at a tip of the strip, said attachment means, strip and contact being integrally formed,
said attachment means being attached to an outer circumferential surface of a glass tube in the discharge tube,
said contact being electrically connected to a lead led outside from an end of the glass tube to supply the lead with electric power through said contact, strip and attachment means.

17. A discharge tube with a connector attached thereto, comprising a glass tube and leads lengthened outside from each end of the glass tube,
said connector comprising attachment means, an elongated strip and a contact formed at a tip of the strip, all of which are integrally formed,
said attachment means being attached to an outer circumferential surface of the glass tube,
said contact being connected to the lead of the discharge tube to supply the lead with electric power through the contact, strip and attachment means.

18. The discharge tube of claim 17, wherein the lead is connected to the contact.

19. The connector of claim 16, wherein at least one fold is formed in the strip.

20. The connector of claim 16, wherein a plurality of radially inwardly protruding bosses are formed on the sleeve.

21. A discharge tube with a metallic connector attached thereto, comprising a glass tube for defining a closed space in which discharge gas is sealed, a pair of metallic electrodes disposed within the closed space, and metallic leads each of which has one end connected to the electrode and the other end lengthened outside from the end of the glass tube,
the connector comprising a sleeve, an elongated strip extending axially outside from one end of the sleeve, and a contact formed at a tip of the strip with folding,
the contact having a penetration or notch in which the lead is positioned to secure the sleeve to an end of the glass tube.

22. A connector for a discharge tube, comprising a sleeve to be attached to an outer circumferential surface of a grass tube end in the discharge tube, an elongated strip extending from the sleeve, and a contact formed at a tip of the strip for connection to a lead lengthened outside from an end of the glass tube,
the sleeve, strip and contact being formed of a metallic material.

23. The connector of claim 22, wherein the strip extending from one end of the sleeve has a narrower width than the diameter of the sleeve.

24. The connector of claim 22, wherein the strip has its elasticity.

25. The connector of claim 22, wherein the strip has at least one fold.

26. A discharge tube with a connector attached thereto, comprising: a glass tube and leads lengthened outside from opposite ends of the glass tube,
wherein said connector comprises attachment means attached to an outer circumferential surface of the glass tube, an elongated strip extending from the attachment means, and a contact formed at a tip of the strip for connection to the lead of the discharge tube to supply the lead with electric power through said contact, strip and attachment.

27. A discharge tube with a connector attached thereto, comprising a glass tube, and leads lengthened from and away from each end of the glass tube,
wherein the connector comprises attachment means attached to an outer circumferential surface of the glass tube, an elongated strip extending from said attachment means, and a contact formed at a tip of the strip for connection to said lead,
said attachment means, strip and contact are formed of a metallic material.

28. The discharge tube of claim 27, wherein said attachment means is a sleeve attached to an end of the glass tube.

29. The discharge tube of claim 28, wherein said strip extends from one end of said sleeve, and
said sleeve has a narrow width than the diameter of the sleeve.

30. The discharge tube of claim 26 or 27, wherein said strip has the elasticity.

31. The discharge tube of claim 26 or 27, wherein the contact is provided at the other end of the strip opposite to one end connected to the attachment means.

32. The discharge tube of claim 26 or 27, wherein the attachment means, strip and contact have substantially the same thickness.

33. The discharge tube of claim 28, further comprising at least a stopper radially inwardly projecting from one end of the sleeve.

34. The discharge tube of claim 26 or 27, further comprising at least a fold provided in the strip.

35. A method for producing a discharge tube with a connector attached thereto, comprising the steps of:
preparing the discharge tube which comprises a glass tube and leads lengthened outside from each end of the glass tube,
preparing the connector which comprises attachment means, an elongated strip and a contact formed at a tip of the strip, and
attaching the attachment means to an outer circumferential surface of the glass tube and electrically connecting the contact to the lead.

36. The method of claim 35, wherein attaching the attachment means comprises attaching a sleeve as the attachment means to an end of the glass tube.

37. The method of claim 35, wherein electrically connecting the contact comprises securing the contact to the lead with a brazing metal.

38. The method of claim 35, wherein the strip has the elasticity.

39. The method of claim 36, wherein the strip has the narrower width than that the diameter of the sleeve.

40. The method of claim 35, wherein the contact is provided at the other end of the strip opposite to one end connected to the attachment means.

41. A display device comprising a discharge tube which has a glass tube and leads lengthened outside from opposite ends of the glass tube,
a connector which has a sleeve for receiving the glass tube, a strip extending from the sleeve, and a connector formed at a tip of the strip for connection to the lead, and
a metallic holder connected to a power source through wires for grasping the sleeve.

42. The display device of claim 41, wherein the strip has the narrower width than that the diameter of the sleeve.

43. The display device of claim 41, wherein the strip has the elasticity.
